(19) United States
(12) Patent Application Publication
(10) Pub. No.: US 2007/0087151 A1
(43) Pub. Date: Apr. 19, 2007

(54) Stainless steel repair patch assembly

(76) Inventors: Dennis Hoffmann SR., Fox Lake, IL (US); Raymond Hubert, St. Anne, IL (US)

Correspondence Address: Michael R. Hull;Miller, Matthias & Hull, Suite 2350, One North Franklin Street, Chicago, IL, 60606, US

(21) Appl. No.: 11/251,115

(22) Filed: Oct. 13, 2005

(51) Int. Cl. B32B 33/00

(52) U.S. Cl. 428/40.1; 428/131; 428/138; 428/119

(57) ABSTRACT

An improved repair patch assembly and method for repairing damaged portions of an exposed surface of wallboard or drywall are disclosed. The repair patch assembly comprises a stainless steel sheet or mesh as opposed to aluminum or galvanized sheets or mesh. The stainless steel sheet provides superior fire resistance despite the fact that the stainless steel sheets used herein are thinner than the conventional aluminum repair patches.

### BACKGROUND

1. Technical Field

An improved repair patch is disclosed which features a stainless steel patch for improved fire resistance. Stainless steel repair patches, in thicknesses ranging from about 5 to about 10 thousandths of an inch (“0.005˜0.010”), provide the requisite formability or ductility needed for a repair patch while providing superior fire resistance to that of conventional aluminum or galvanized patches. An improved method of repairing a wall or surface is also disclosed.

2. Description of the Related Art

In modern day building construction, interior walls and partitions are often constructed of wallboard panels, which are generally referred to as drywall, gypsum board, plasterboard, or Sheetrock™. Essentially, these panels are made of a hardened plaster-like gypsum material which is sandwiched between sheets of paper or paperboard.

In a typical building construction process, wooden studs are assembled to form a frame that outlines the dimensions of a room. Wallboard panels are then nailed or screwed to the studs to form a substantially flat wall or ceiling surface. Any indentations in the wallboard panels, such as those formed by driving nails into the wallboard, are filled in with drywall compound, commonly referred to as “mud,” and the drywall compound is smoothed out with a flat-bladed tool such as a trowel or scraper. The drywall compound is then allowed to dry and harden. Optionally, the hardened drywall compound may be sanded to a smooth finish.

While the use of wallboard panels in building construction provides numerous advantages including ease of installation and relatively low cost, the use of these panels does present certain disadvantages. Namely, wallboard material is easily damaged by a blow applied to the surface. For example, the impact caused by a protruding door knob on a swinging door has been known to create an unsightly indentation or hole in the wallboard. In addition, it is not uncommon for wallboard to be damaged when contacted by furniture being moved around a room. Children and adolescents have also been known to put holes in wallboard.

To solve this problem, aluminum and galvanized repair patches are known in the art and these repair patches have been used both for repairing holes in drywall material as well as repairing holes in automobile bodies. For example, U.S. Pat. No. 5,075,149 issued to Owens et al. (“Owens”), U.S. Pat. No. 4,707,391 issued to Hoffmann (“Hoffmann '391”), U.S. Pat. No. 4,135,017 issued to Hoffmann (“Hoffmann '017”) and U.S. Pat. No. 5,620,768 issued to Hoffmann (“Hoffmann '768”) are all directed to aluminum repair patches.

Owens discloses a three-layered patch with a metal plate disclosed between two polyester sheets. The metal plate is held in place between the two polyester sheets with a semi-solid adhesive such as urethane. The semi-solid urethane adhesive fixedly attaches the two polyester sheets together as well as fixedly attaching the reinforcing metal plate between the two sheets. Owens is not useful for repairs which require the application of bonding material or plaster to the repair patch because the bonding material or plaster cannot readily pass through the mesh due to the presence of the urethane adhesive. Also, Owens provides little or no fire resistance as the urethane adhesive is highly combustible and readily permits flames to enter the wall through the repaired hole.

Galvanized patches have never found wide acceptance as drywall patches. Specifically, to manufacture a galvanized patch at a competitive price point, stock galvanized sheeting is cut to size to form the individual patches. As a result, the protective galvanized coating is removed from the side edges, leaving the edges prone to rust. The rust from the edges then tends to bleed through drywall compound and paint. Consequentially, galvanized patches are rarely used and aluminum dominates the repair patch market.

Hoffmann '391 discloses a two-layer patch including a perforated aluminum plate with an outer fiberglass mesh attached to one side of the plate. A glue or adhesive coating is applied to the surface of the plate that is attached to the surface to be repaired and an additional adhesive coating is applied to the inward-facing surface of the fiberglass mesh to attach the mesh to the aluminum plate as well as to attach the mesh to the surface under repair. Hoffmann '017 also discloses a two-layer patch. A rigid inner aluminum plate is covered with adhesive that secures one surface of the plate to the surface under repair. An outer plate cover is laminated onto the exterior side of the aluminum plate by means of a layer of adhesive applied to the inward-facing side of the plate cover. Hoffman '768 discloses an improvement over the above patches by avoiding the need to apply adhesive directly to the aluminum plate. All three of the Hoffmann patents rely upon the use of aluminum plates or mesh which provide little, if any fire resistance.

Thus, one problem not addressed by the available repair patches is fire resistance. Specifically, when the integrity of a section of wallboard is compromised by a hole, which is subsequently patched using a conventional aluminum patch or urethane/metal patch as described above, the patch provides little or no resistance to fire the therefore the hole provides a conduit for fire to pass through the damaged wall and to an adjacent room. Recent testing reveals that the currently available aluminum patches provide essentially no fire resistance; the patches quickly disintegrate and allow fire to enter the repaired hole. Specifically, tests with a 930° F. torch applied to a conventional aluminum patch results in an easy penetration of the torch flame and therefore negligible resistance. The urethane of the Owens patch readily combusts and also permits easy penetration of the torch. As a result, the only fire-safe way to fix a hole in a section of wallboard is to use a carefully sized piece of replacement wallboard to fix the hole, which is time intensive and difficult for the typical consumer to do.

Typical aluminum repair patches are about 12.5 thousandths of an inch thick (0.0125″). The use of thicker aluminum plates would not be suitable for repair patches as they would not provide the needed formability or ductility and would create finishing and sanding problems. Also, thicker aluminum plates would dramatically increase the cost of such repair patches. Accordingly, there is a need for an improved patch method for repairing damaged portions of wallboard that will provide substantial fire resistance.

### SUMMARY OF THE DISCLOSURE

In satisfaction of the aforenoted needs, an improved repair patch assembly for covering a hole in a surface is disclosed. The improved repair patch assembly comprises a stainless steel sheet having an inward facing side and an outward facing side. The improved patch is free urethane, epoxy or adhesives that set-up or dry in a rigid state. Only pressure sensitive adhesives are used. The stainless steel sheet has a thickness ranging from about 0.005 to about 0.010 inches thick (˜0.005˜0.010″). Surprisingly, stainless steel of this thickness range provides the requisite ductility and formability needed for non-planar repair jobs while also providing significant and valuable fire resistance. For example, a 930° F. torch applied to a stainless steel patch made in accordance with this disclosure required 15 minutes to penetrate the patch. In contrast, conventional aluminum and galvanized patches disintegrate almost immediately when exposed to such a torch under the same test procedures.

In a refinement, the assembly includes an outer mesh sheet having a width and a length greater than the width and length of the stainless steel sheet to provide an outer border when the outer mesh sheet is disposed on the outward facing side of the stainless steel sheet. The inward facing side of the outer mesh sheet is preferably coated with adhesive to secure the outer mesh sheet to the outward facing side of the stainless steel sheet and the outer border of the outer mesh sheet to the surface under repair.

In another refinement, the stainless steel sheet of the disclosed repair patch assembly is solid.

In another refinement, the stainless steel sheet of the disclosed repair patch assembly is perforated.

In another refinement, the stainless steel sheet of the disclosed repair patch assembly comprises expanded perforations or holes (i.e., a perforated stainless steel sheet is passed through rollers to reduce the thickness of the sheet and enlarge the holes or openings).

In another refinement, the stainless steel sheet comprises a plurality of tabs directed inward from the inwardly facing side of the stainless steel sheet. The tabs are pointed for penetrating the surface under repair, i.e., a section of wallboard. In further refinement, the stainless steel sheet comprises four corners and four side edges, and the plurality of tabs comprises four tabs, one at each corner. In a further refinement of this concept, the plurality of tabs comprising four tabs, one along each side edge. In still a further of this concept, the plurality of tabs comprises eight tabs, one at each corner and one along each side edge.

In another refinement, the repair patch assembly comprises an inner mesh sheet that has a width and a length greater than the width and length of the stainless steel sheet to provide an outer border when the inner mesh is disposed on the inward facing side of the stainless steel sheet and between the stainless steel sheet and the surface under repair. The inner mesh sheet has an inward facing side and an outward facing side, each coated with adhesive to secure the inner mesh sheet to the surface under repair and to the inward facing side of the stainless steel sheet and to the outer border of outer mesh.

In another refinement, the patch assembly includes a piece of release paper detachably connected to the inner mesh sheet.

A method for repairing a hole in a wall is also disclosed. The method comprises applying any one of the repair patch assemblies described above over a hole or indentation in a wall, coating the assembly with a drywall repair compound, allowing the compound to dry, and, optionally, sanding dry compound.

### BRIEF DESCRIPTION OF THE DRAWINGS

These and other features, aspects, and advantages of the disclosed repair patch assemblies will become better understood upon consideration of the following detailed description, appended claims and accompanying drawings wherein:

FIG. 1 is an exploded perspective view of a disclosed repair patch including a thin stainless steel sheet sandwiched between inner and outer mesh sheets and removable release papers;

FIG. 2 is a partial perspective view of a section of drywall, showing in phantom lines the drywall patch of FIG. 1 disposed thereon and covering and repairing a hole in the drywall;

FIG. 3 is an exploded perspective view of a second disclosed repair patch including a thin stainless steel sheet with expanded perforations in the sheet and which is sandwiched between inner and outer mesh sheets and removable release papers;

FIG. 4 is an enlarged partial view of the perforated steel sheet and outer mesh of the patch assembly shown in FIG. 3;

FIG. 5 is a partial perspective view of a section of drywall, showing in phantom lines, the drywall patch of FIGS. 3 and 4 disposed thereon and covering and repairing a hole in the drywall;

FIG. 6 is an exploded perspective view of a third disclosed repair patch including a thin stainless steel sheet sandwiched between inner and outer mesh sheets and removable release papers;

FIG. 7 is an enlarged partial view of the perforated steel sheet and outer mesh of the patch assembly shown in FIG. 6; and

FIG. 8 is a partial perspective view of a section of drywall, showing in phantom lines the drywall patch of FIGS. 6 and 7 disposed thereon and covering and repairing a hole in the drywall.

It should be understood that the drawings are not necessarily to scale and that the embodiments are sometimes illustrated by phantom lines, diagrammatic representations and fragmentary views. In certain instances, details which are not necessary for an understanding of the disclosed embodiments or which render other details difficult to perceive may have been omitted. It should be understood, of course, that this disclosure is not necessarily limited to the particular embodiments illustrated herein.

Like reference numerals will be used to refer to like or similar parts from Figure to Figure in the following description of the drawings.

### DETAILED DESCRIPTION OF THE PRESENTLY PREFERRED EMBODIMENTS

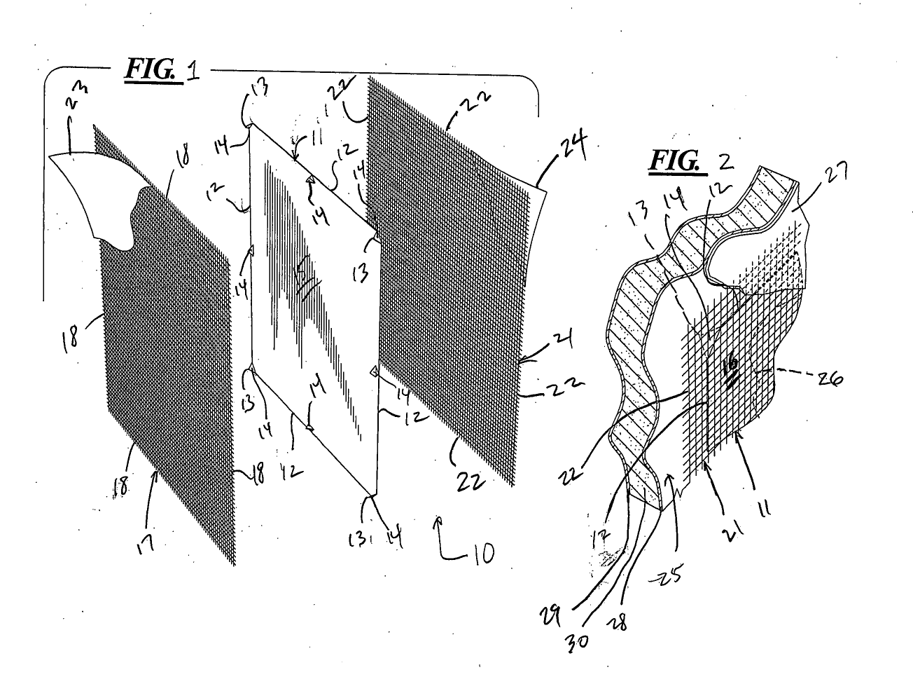

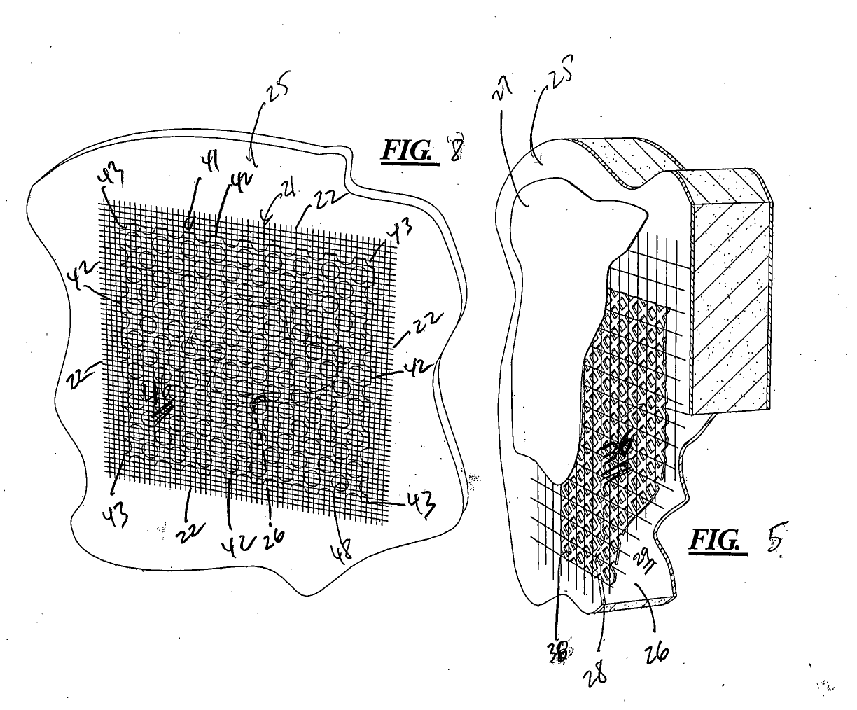

Referring now to FIG. 1, a drywall repair patch assembly 10 is disclosed which is suitable for use in the repair of drywall, wallboard or other surfaces prone to damage in the form of holes and indentations. The drywall patch assembly 10 includes a relatively rigid stainless steel plate or sheet 11. It has been found that thin gauge stainless steel provides superior fire resistance to that of conventional thin gauge aluminum or galvanized steel sheeting. Most preferably, the stainless steel sheet 11 has a thickness less than the thickness of the paper layers 28 covering the plaster layer 29 in commercially available drywall (see FIGS. 2 and 5).

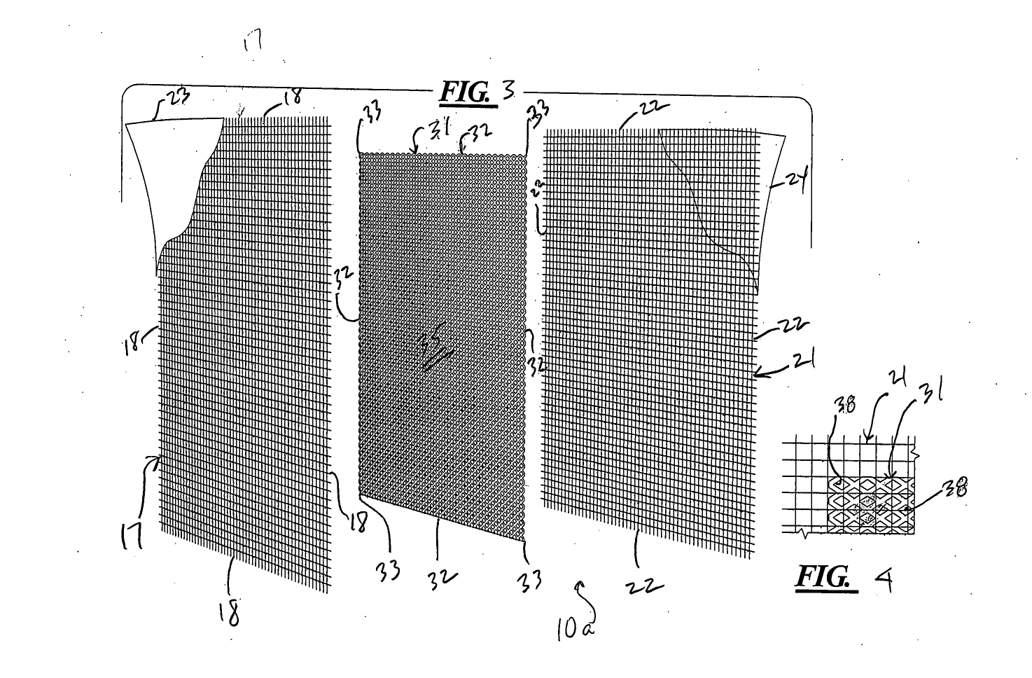

The plate or sheet 11 has top, bottom and side edges shown generally at 12 as well as four corners shown generally at 13. The corners 13 provide a convenient place for form inwardly protruding tabs shown at 14. The tabs 14 extend inwardly from the inward facing side 15 of the stainless steel sheet 11. Preferably, the tabs 14 are pointed or sharpened so they can serve as a penetrating anchor when the sheet 11 is mounted onto a piece of damaged drywall 25 as shown in FIG. 2. Opposite the inwardly facing side 15 of the sheet 11 is an outwardly facing side 16 (FIG. 2). In the embodiment shown in FIGS. 1 and 2, the sheet 11 is free of perforations or holes in contrast to the embodiments shown at 31 (FIGS. 3-5) and 41 (FIGS. 6-8).

Referring back to FIG. 1, the assembly 10 may optionally include an inner mesh sheet 17 and/or and outer mesh sheet 21. The inner mesh sheet 17 includes four outer edges shown at 18. The width and length of the inner mesh sheet 18 are preferably larger than that of the stainless steel sheet 11 so the mesh 17 provides an outer border that extends beyond the outer edges 12 of the stainless steel sheet 11. The inner mesh sheet 17 is useful for two reasons. First, adhesive may be applied to the inner mesh sheet 17 more easily than to the stainless steel sheet 11 for the reasons set forth in Hoffmann '768. Thus, the inner mesh 17 can be used to help adhere the stainless steel sheet 11 to the wallboard 25, especially if the anchoring tabs 14 are not utilized as with the stainless steel sheets shown at 31 in FIGS. 3-5 and at 41 in FIGS. 6-8. Second, the inner mesh sheet 17 can serve as matrix for holding drywall compound to provide a smooth transition between the stainless steel sheet 11 and the wallboard 25 or, more specifically, between the sheet 11 and the paper covering layer 28 of the wallboard 25.

The outer mesh 21 shown in FIG. 1, while also optional, may be more functional than the inner mesh sheet 17. The outer mesh sheet 21 is also preferably coated with adhesive to secure the outer mesh sheet 21 to the outward facing surface 16 of the stainless steel sheet 11. The outer mesh sheet 21 should be wider and longer than the stainless steel sheet 11 so that the outer mesh sheet 21 provides an outer border or margin that, when coated with adhesive on an inner side thereof, helps to secure the stainless steel sheet 11 to the wallboard 25. Using the outer mesh sheet 21 to secure the sheet 11 to the wallboard 25 is particularly important if the anchoring tabs 14 are not utilized.

The inner mesh sheet 17 and outer mesh sheet 21, when utilized, and when covered by adhesive, may be packaged with release papers shown at 23 and 24 in FIG. 1. The adhesive, when needed, should be a pressure sensitive adhesive such as National Brand No. 33-4034 or Product No. 72-5405 sold by National Starch and Chemical Corporation of Bridgewater, N.J. These two pressure-sensitive adhesives are polymer emulsions. Product 72-5405 is characterized as an acrylic polymer emulsion. Both adhesives are water soluble. Neither adhesive contains urethane, epoxy or adhesive materials that dry or set-up in a solid or rigid state. Suitable adhesives for the purposes addressed in this disclosure do not cure or otherwise go through a phase change. Such pressure-sensitive adhesives are well known to those skilled in the art. The release papers 23, 24 may be household wax paper or silicone treated paper such as 1-40 BK 6-169 or two-sided released coated kraft paper such as 2-40BKG-1&99 Series kraft paper. Other suitable release papers such as coated kraft papers and wax papers will be known to those skilled in the art. Other suggested materials and manufacturers are listed in Owens, Hoffmann '017 and Hoffmann '391.

Referring now to FIG. 2, the drywall patch assembly 10 (without the inner mesh sheet 17 of FIG. 1) has been mounted on a section of drywall generally designated at 25. The drywall section 25 comprises a first outer paper layer 28 and a second outer paper layer 29 which sandwich a plaster layer 30. The first outer paper layer 28 has an outside surface which is exposed when the drywall 25 is installed on wooden studs. As shown in FIG. 2, the drywall 25 is damaged in the form of a hole shown in phantom at 26. The assembly 10 (without the inner mesh 17) is installed on the drywall 25 so that the stainless steel sheet 11 covers the hole 26 and the outer mesh sheet 21 covers the stainless steel sheet 11. The tabs 14, in combination with the adhesive-coated outer mesh sheet 21, secure the stainless steel sheet 11 in place so drywall compound may be applied and sanded to finish the repair job.

Referring now to FIG. 3, a second drywall repair patch assembly 10a is disclosed which is also suitable for use in the repair of drywall, wallboard or other surfaces prone to damage in the form of holes and indentations. The drywall patch assembly 10a also includes a thin and relatively rigid stainless steel plate or sheet 31. However, the stainless steel sheet 31 includes multiple expanded openings or perforations shown at 38 in FIGS. 4 and 5. The plate or sheet 31 has top, bottom and side edges shown generally at 32 as well as four corners shown generally at 33. Opposite the inwardly facing side 35 of the sheet 31 is an outwardly facing side 36 (FIGS. 4-5). Referring back to FIG. 3, the assembly 10a may optionally include an inner mesh sheet 17 and/or and outer mesh sheet 21 as well as release papers 24, 25. The sizing and function of the inner and outer mesh sheets 17, 21 are the same as those discussed above in connection with FIGS. 1-2.

Referring now to FIG. 5, the drywall patch 10a (without the inner mesh 17) is shown applied to repair a hole 26 in a drywall section 25, and after installed, is covered by a thin layer of plaster, spackle or other curable drywall repair compound 27. The openings 38 in the stainless steel sheet help to retain the drywall compound 27 for a smooth, hidden finish.

Surprisingly, despite the presence of the openings 38, the stainless steel sheet 31 provides substantial and possibly life-saving fire resistance. In fact, the sheet 31 provided approximately 15 seconds of resistance to a 930° F. torch, similar to the solid stainless steel sheet 11 of FIGS. 1-2. Despite the openings or perforations 38, the 0.005˜0.010″ stainless steel sheet 31 provided superior fire resistance to that of thicker (0.0125) sheet of aluminum.

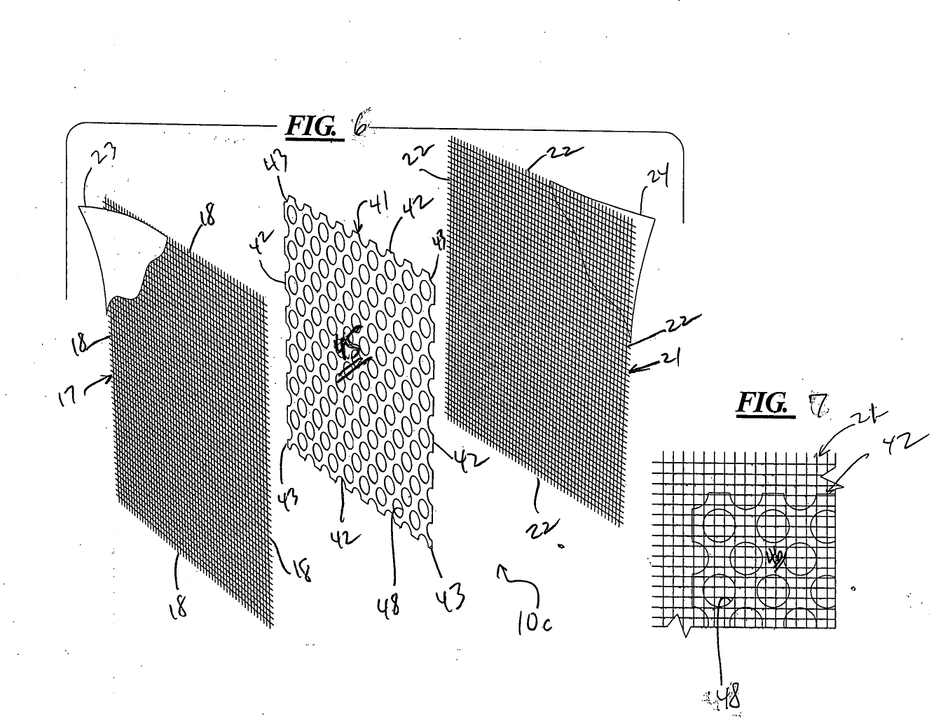

Referring now to FIG. 6, a third drywall repair patch assembly 10c is disclosed which is also suitable for use in the repair of drywall, wallboard or other surfaces prone to damage in the form of holes and indentations. The drywall patch assembly 10c also includes a thin and relatively rigid stainless steel plate or sheet 31, with openings or perforations shown at 48 in FIGS. 6-8. The plate or sheet 41 has top, bottom and side edges shown generally at 42 as well as four corners shown generally at 43. Opposite the inwardly facing side 45 of the sheet 41 (FIG. 6) is an outwardly facing side 46 (FIGS. 7-8). Referring back to FIG. 6, the assembly 10c may optionally include an inner mesh sheet 17 and/or and outer mesh sheet 21 as well as release papers 24, 25. The sizing and function of the inner and outer mesh sheets 17, 21 are the same as those discussed above in connection with FIGS. 1-2. As shown in FIGS. 7-8 the inner and outer mesh sheets 17, 21 (only the outer mesh sheet 21 is shown in FIGS. 7-8) should be sized so they are wider and longer than the stainless steel sheet 41 and therefore extend beyond the outer edges 42 of the sheet 41 to create an outer border so that the adhesive covered mesh 17 and 21 can help hold the stainless steel sheet 41 to the wall while the drywall compound (not shown in FIGS. 6-8) is applied and dried.

Referring to FIG. 8, the drywall patch 10b (without the inner mesh 17) is shown applied to repair a hole 26 in a drywall section 25. The stainless steel sheet 41 should be large enough to cover the entire hole 26 as shown.

Surprisingly, despite the presence of the perforations 48, the stainless steel sheet 41 provides substantial and possibly life-saving fire resistance. In fact, the sheet 41 provided approximately 15 seconds of resistance to a 930° F. torch, just like the solid stainless steel sheet 11 of FIGS. 1-2 and the expanded sheet of FIGS. 3-5. Despite the openings or perforations 48, the 0.005˜0.010″ stainless steel sheet 31 provided superior fire resistance to that of thicker (0.0125) sheet of aluminum.

One skilled in the art will appreciate that the concepts and techniques disclosed herein can be practiced by other than the preferred embodiments described above. Therefore, the spirit and scope of the appended claims should not be limited to the description of the preferred embodiments contained herein.

What is claimed:

1. A repair patch assembly for covering a hole in a surface, the assembly comprising:
a stainless steel sheet having an inward facing side and an outward facing side, the stainless steel sheet having a thickness ranging from about 0.007 to about 0.010 inches thick, the stainless steel sheet having a width and a length,
the steel sheet further comprising a plurality of tabs directed inward from the inwardly facing side of the stainless steel sheet, the tabs being pointed for penetrating the surface under repair,
an outer mesh sheet having a width and a length greater than the width and length of the stainless steel sheet to provide an outer border when the outer mesh sheet is disposed on the outward facing side of the stainless steel sheet, the outer mesh sheet having an inward facing side coated with pressure sensitive adhesive to secure the outer mesh sheet to the outward facing side of the stainless steel sheet and the outer border to the surface under repair.

2. The repair patch assembly of claim 1 wherein the stainless steel sheet is solid.

3. The repair patch assembly of claim 1 wherein the stainless steel sheet comprises four corners and four side edges, the plurality of tabs comprising four tabs, one at each corner.

4. The repair patch assembly of claim 1 wherein the stainless steel sheet comprises four corners and four side edges, the plurality of tabs comprising four tabs, one along each side.

5. The repair patch assembly of claim 1 wherein the stainless steel sheet comprised four corners and four side edges, the plurality of tabs comprising eight tabs, one at each corner and one along each side.

6. The repair patch assembly of claim 1 further comprising an inner mesh sheet having a width and a length greater than the width and length of the stainless steel sheet to provide an outer border when the inner mesh is disposed on the inward facing side of the stainless steel sheet and between the stainless steel sheet and the surface under repair, the inner mesh sheet having an inward facing side and an outward facing side each coated with pressure sensitive adhesive to secure the inner mesh sheet to the surface under repair and to the inward facing side of the stainless steel sheet and to the outer border of outer mesh.

7. The repair patch assembly of claim 1 further comprising a piece of release paper detachably connected to the inner mesh sheet.

8. The repair patch assembly of claim 1 wherein the stainless steel sheet is perforated.

9. The repair patch assembly of claim 1 wherein the stainless steel sheet comprises a plurality of expanded perforations.

10. A repair patch assembly for covering a hole in a surface, the assembly comprising:
a stainless steel sheet having an inward facing side and an outward facing side, the stainless steel sheet having a thickness ranging from about 0.007 to about 0.010 inches thick,
the stainless steel sheet further comprising a plurality of tabs directed inward from the inwardly facing side of the stainless steel sheet, the tabs being pointed for penetrating the surface under repair.

11. The repair patch assembly of claim 10 wherein the stainless steel sheet having a width and a length,
the assembly further comprising an outer mesh sheet having a width and a length greater than the width and length of the stainless steel sheet to provide an outer border when the outer mesh sheet is disposed on the outward facing side of the stainless steel sheet, the outer mesh sheet having an inward facing side coated with pressure sensitive adhesive to secure the outer mesh sheet to the outward facing side of the stainless steel sheet and the outer border to the surface under repair.

12. The repair patch assembly of claim 10 wherein the stainless steel sheet comprises four corners and four side edges, the plurality of tabs comprising four tabs, one at each corner.

13. The repair patch assembly of claim 10 wherein the stainless steel sheet comprises four corners and four side edges, the plurality of tabs comprising four tabs, one along each side.

14. The repair patch assembly of claim 10 wherein the stainless steel sheet comprises four corners and four side edges, the plurality of tabs comprising eight tabs, one at each corner and one along each side.

15. The repair patch assembly of claim 11 further comprising an inner mesh sheet having a width and a length greater than the width and length of the stainless steel sheet to provide an outer border when the inner mesh is disposed on the inward facing side of the stainless steel sheet and between the stainless steel sheet and the surface under repair, the inner mesh sheet having an inward facing side and an outward facing side each coated with adhesive to secure the inner mesh sheet to the surface under repair and to the inward facing side of the stainless steel sheet and to the outer border of outer mesh.

16. The repair patch assembly of claim 10 wherein the stainless steel sheet is perforated.

17. The repair patch assembly of claim 10 wherein the stainless steel sheet comprises a plurality of expanded perforations.

18. A repair patch assembly for covering a hole in a surface, the assembly comprising:
a stainless steel sheet having an inward facing side and an outward facing side, the stainless steel sheet having a thickness ranging from about 0.007 to about 0.010 inches thick, the stainless steel sheet having a width and a length,
an outer mesh sheet having a width and a length greater than the width and length of the stainless steel sheet to provide an outer border when the outer mesh sheet is disposed on the outward facing side of the stainless steel sheet, the outer mesh sheet having an inward facing side coated with adhesive to secure the outer mesh sheet to the outward facing side of the stainless steel sheet and the outer border to the surface under repair,
the assembly further comprising an inner mesh sheet having a width and a length greater than the width and length of the stainless steel sheet to provide an outer border when the inner mesh is disposed on the inward facing side of the stainless steel sheet and between the stainless steel sheet and the surface under repair, the inner mesh sheet having an inward facing side and an outward facing side each coated with adhesive to secure the inner mesh sheet to the surface under repair and to the inward facing side of the stainless steel sheet and to the outer border of outer mesh,
the stainless steel sheet further comprising a plurality of tabs directed inward from the inwardly facing side of the stainless steel sheet, the tabs being pointed for penetrating the surface under repair, wherein the stainless steel sheet comprises four corners and four side edges, the plurality of tabs comprising eight tabs, one at each corner and one along each side.

19. A method for repairing a hole in a wall, the method comprising:
applying the repair patch assembly of claim 1 over a hole in a wall,
coating the assembly with a wall repair slurry,
allowing the slurry to dry,
sanding the slurry.
